(19) United States
(12) Patent Application Publication
(10) Pub. No.: US 2012/0131143 A1
(43) Pub. Date: May 24, 2012

(54) USER DEVICE IDENTIFYING METHOD AND INFORMATION PROCESSING SYSTEM

(75) Inventor: Toshiyuki Nakazawa, Tokyo (JP)

(73) Assignee: CANON KABUSHIKI KAISHA, Tokyo (JP)

(21) Appl. No.: 13/255,235

(22) PCT Filed: May 31, 2011
(86) PCT No.: PCT/JP2011/003018

§ 371 Date: Sep. 7, 2011

(30) Foreign Application Priority Data
Jun. 4, 2010 (JP) 2010-128428

(51) Int. Cl. G06F 15/16

(52) U.S. Cl. 709/218

(57) ABSTRACT

A Web application receives a request from a Web browser, and provides an instruction to a Web browser to redirect the Web browser to a signature application. The Web browser is redirected to the signature application, and then the signature application generates a signature and provides an instruction to the Web browser to redirect the Web browser to the Web application. The Web application which has received the redirect confirms that the signature is correct, and the Web application identifies a user device on which the Web browser of the redirect source operates as a user device on which the Web browser which transmits the request operates.

### TECHNICAL FIELD

The present invention relates to a user device identifying method and an information processing system.

### BACKGROUND ART

A Web system for utilizing an application via a network has been proposed. In the Web system, a Web application resides on a server. A Web browser provided in a user device transmits an HTTP request by identifying a URL for the Web application, and thus is capable of displaying the Web page of the Web application, where URL is an abbreviation for “Uniform Resource Locator”, and HTTP is an abbreviation for “HyperText Transfer Protocol”. It is contemplated that the image processing functions of an image forming apparatuses such as copy machines, printers, facsimiles, multi-function peripherals, and the like are provided by the Web application. According to such image forming apparatuses, a user inputs the URL of the function (Web application) that the user wishes to employ to a Web browser or the like, and thereby the user can remotely employ the image processing functions of the image forming apparatuses.

As a technology for identifying a user device on which a Web browser operates in a Web application, a system in which the Web browser acquires information for identifying a user device, and transmits the information to the Web application has been proposed. For example, Japanese Patent Laid-Open No. 2003-143133 proposes an authentication system in which a Web browser transmits a certificate number to a service providing apparatus and a management apparatus determines whether or not an information terminal is allowed to view the Web image based on a user certificate corresponding to the certificate number.

In a system in which a plurality of user devices (for example, image forming apparatuses) accesses the same server, such as a cloud computing system or the like, the necessity of identifying which user device made a request relating to image processing (for example, a request relating to scan processing or a print request) is high.

However, in the system in which a Web browser acquires information for identifying a user device and transmits the information to a Web application, the Web browser needs to be customized for the acquisition and transmission of information for identifying a user device. Also, when modification is made to the framework for identifying a user device, the Web browser itself also needs to be changed. In addition, the TLS client authentication technology disclosed in Japanese Patent Laid-Open No. 2003-143133 is a standard for a transport layer. Thus, it is difficult for a Web application to acquire information relating to a client (a terminal on which a Web browser operates) that has been authenticated by the TLS client authentication function. In addition, a Web browser needs to incorporate the client authentication function.

### CITATION LIST

### Patent Literature

PTL 1: Patent Document 1: Japanese Patent Laid-Open No. 2003-143133

### SUMMARY OF INVENTION

The present invention provides a user device identifying method in which a Web application can identify a user device on which a Web browser operates without implementation of any special framework in the Web browser.

According to an aspect of the present invention, a user device identifying method is provided wherein: a Web application of a server device generates and stores unique information in response to the receipt of a request from a Web browser provided in a user device, and transmits the unique information and an instruction to redirect the Web browser to a signature information generation unit provided in the user device to the Web browser; the signature information generation unit receives the unique information transmitted by the Web browser in accordance with the instruction, generates signature information based on the received unique information, and transmits an instruction to the Web browser to redirect the Web browser to the Web application including the signature information and the unique information; and the Web application receives a redirect from the Web browser in accordance with the instruction, confirms whether or not signature information included in the redirect is correct when unique information included in the received redirect matches the stored unique information, and identifies the user device when it is confirmed that the signature information is correct.

Further features of the present invention will become apparent from the following description of exemplary embodiments with reference to the attached drawings.

### BRIEF DESCRIPTION OF DRAWINGS

FIG. 1 is a diagram illustrating an example of the information processing system of the present embodiment.

FIG. 2 is a diagram illustrating an example of the hardware configuration of an application server.

FIG. 3 is a diagram illustrating an example of the hardware configuration of a user device.

FIG. 4 is a sequence diagram illustrating image data read processing.

FIG. 5 is a sequence diagram illustrating user device identifying processing.

FIG. 6A is a diagram illustrating an example of an HTTP request.

FIG. 6B is a diagram illustrating an example of an HTTP response.

FIG. 6C is a diagram illustrating an example of an HTTP response.

FIG. 7 is a sequence diagram illustrating print data printing processing.

FIG. 8 is a sequence diagram illustrating user device identifying processing.

FIG. 9 is a diagram illustrating an example of the reception processing flow of an HTTP request.

### DESCRIPTION OF EMBODIMENTS

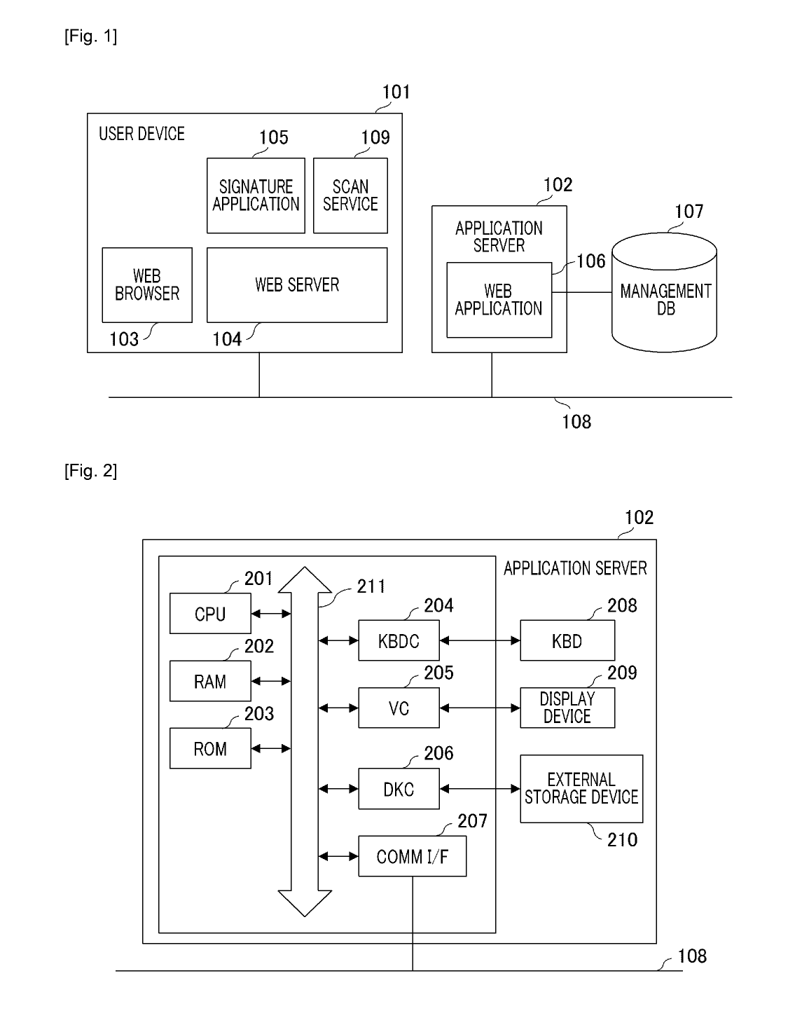

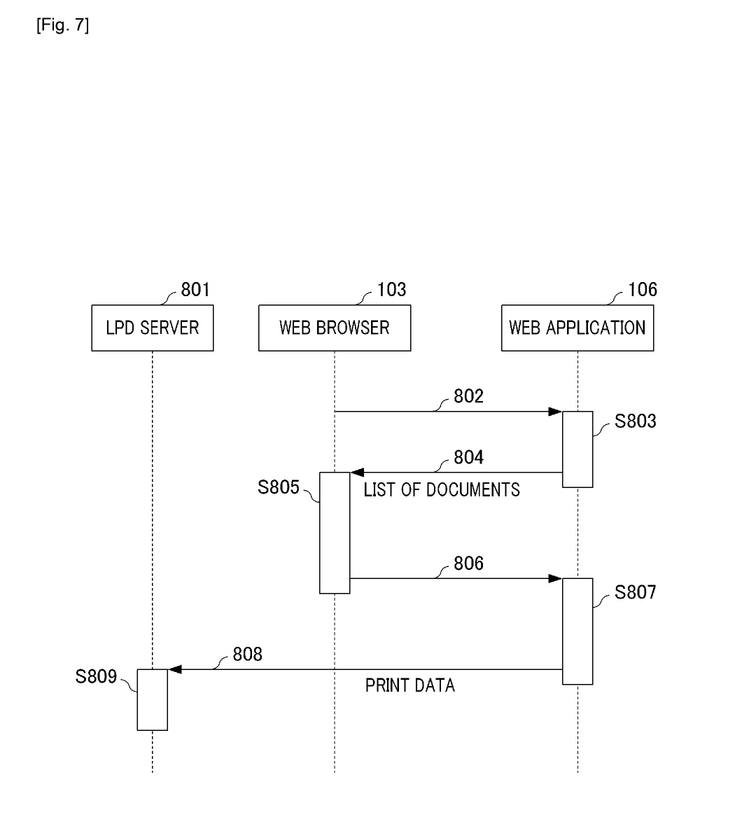

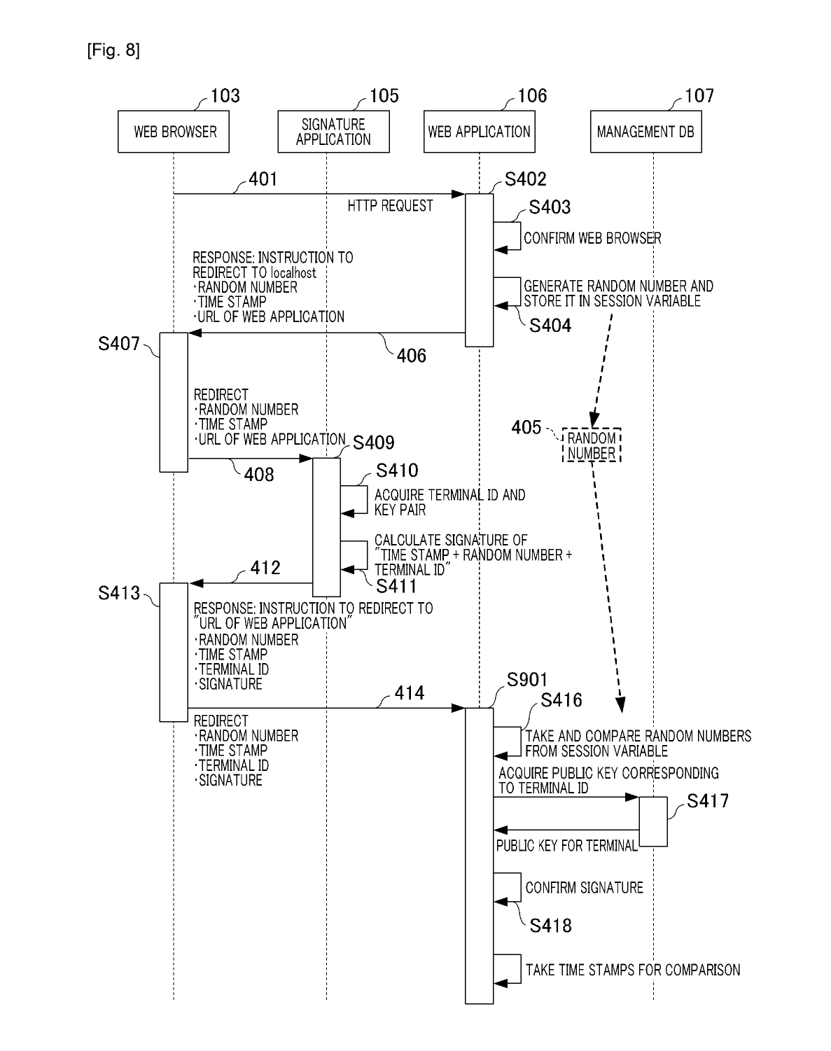

FIG. 1 is a diagram illustrating an example of the information processing system of the present embodiment. The information processing system of the present embodiment realizes a user device identifying method for identifying a user device on which a Web browser operates by a Web application. The information processing system shown in FIG. 1 includes a user device 101 and an application server 102. The user device 101 and the application server 102 are connected to each other via a network 108. The user device 101 is an information processing apparatus (or terminal) operated by a user. The user device 101 is, for example, a digital multi-function peripheral. With the enhancement of the digital multi-function peripheral, the digital multi-function peripheral includes an application environment for operating a Web browser function, a business application, or the like. The application environment is, for example, an execution environment of a Java (Registered Trademark) application or an execution environment of a Web application using Servlet of Java (Registered Trademark). When the user device 101 functions as a digital multi-function peripheral, the user device 101 includes an image reading unit for reading an image, and an LPD server 801 (see FIG. 7, not shown in FIG. 1) that controls print data printing processing.

The user device 101 makes a request to an application server 102. The application server 102 is an information processing apparatus that executes processing in response to the request received from the user device 101. The user device 101 includes a Web browser 103, a Web server 104, a signature application 105, and a scan service 109. The Web browser 103 is connected to a Web application 106 provided in the application server 102, and uses the functions (for example, the functions of a scan application) provided by the Web application 106. The Web browser 103 transmits an HTTP request to the Web application 106 upon the start of the connection to the Web application. Also, the Web browser 103 is redirected to the signature application 105 in accordance with a redirect instruction received from the Web application 106 (executes a first redirect step). Further, the Web browser 103 is redirected to the Web application 106 in accordance with a redirect instruction received from the signature application 105 (executes a second redirect step). The Web browser 103 passes signature information (hereinafter referred to simply as “signature”) included in the redirect instruction to the Web application 106. The signature application 105 to be described below generates the signature.

The Web server 104 controls the scan service 109 that operates on the Web server 104. The scan service 109 is provided as, for example, Servlet. The scan service 109 reads an image from, for example, an image reading unit in accordance with the instruction given by the Web application 106, and transmits the read image data to the Web application 106.

The signature application 105 functions as a signature information generation unit that generates a signature corresponding to the user device 101. The signature application 105 provides an instruction to the Web browser 103 to redirect the Web browser to the Web application, and passes the generated signature to the Web browser 103 through the redirect instruction (executes a second redirect instruction step).

The application server 102 is a server device that includes a Web application 106 and a management database (DB) 107. The Web application 106 receives an HTTP request from the Web browser 103 of the user device 101. The Web application 106 provides an instruction to the Web browser that is the transmission source of the request to redirect the Web browser to the signature application 105 (executes a first redirect instruction step). Also, the Web application 106 receives the redirect from the Web application, and confirms whether or not the signature passed through the redirect is correct. When the Web application 106 confirms that the signature is correct, the Web application 106 identifies the user device on which the Web browser 103 of the redirect source operates as the user device 101 in which the Web browser which has transmitted the request operates (executes a device identification step).

The management DB 107 is a storage unit that stores a terminal ID, a public key corresponding to the user device 101, and various data to be employed by the Web application 106. The terminal ID is identification information that uniquely identifies the user device 101. The public key is employed by the Web application 106 for confirming whether or not the signature passed from the Web browser is correct. The management DB 107 may be operated within the application server 102, or may be operated on a host computer (not shown) that is connected to the user device 101 via the network 108.

FIG. 2 is a diagram illustrating an example of the hardware configuration of an application server. The application server 102 includes a CPU (Central Processing Unit) 201, RAM (Random Access Memory) 202, and ROM (Read Only Memory) 203. Also, the application server 102 includes a keyboard controller (KBDC) 204, a video controller (VC) 205, and a disk controller (DKC) 206. The application server 102 includes a COMM I/F (Interface) 207, a keyboard (KBD) 208, a display device 209, and an external storage device 210. The CPU 201 to the COMM I/F 207 are connected to a system bus 211.

The CPU 201 controls the application server 102 overall. More specifically, the CPU 102 executes a program that is stored in the ROM 203 or the external storage device 210 or has been downloaded via the network 108, and integrally controls the devices that are connected to the system bus 211. Note that the external storage device 210 has a hard disk, a floppy (Registered Trademark) disk, and the like. The RAM 202 functions as the main memory of the CPU 201 or a working area. The ROM 203 stores in advance a program to be executed by the CPU 201.

The KBDC 204 sends input information, which has been input by the KBD 208 or a pointing device (not shown), to the CPU 201. The VC 205 controls display processing performed by the display device 209 that consists of a CRT (Cathode Ray Tube), a LCD (Liquid Crystal Display), and the like. The DKC 206 controls access from a device connected to the system bus 211 to the external storage device 210. The COMM I/F 207 functions as a communication controller, and connects the application server 102 to the network 108.

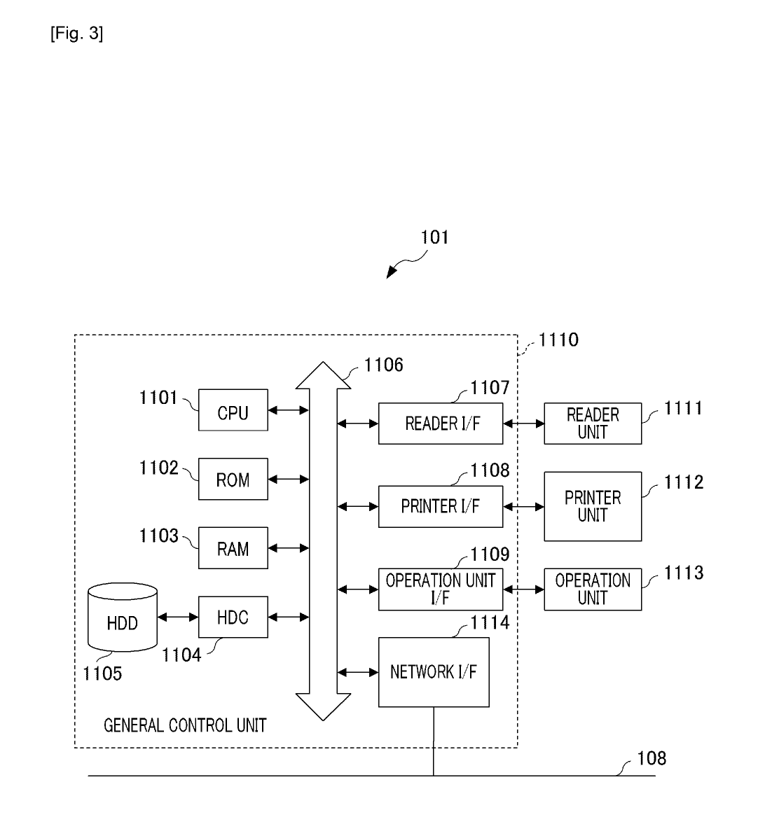

FIG. 3 is a diagram illustrating an example of the hardware configuration of a user device. In FIG. 3, a description will be given of the hardware configuration of the user device 101 that functions as a digital multi-function peripheral. The user device 101 includes a general control unit 1110, a reader unit 1111, a printer unit 1112, and an operation unit 1113. The general control unit 1110 controls the various devices and interfaces that are connected to the user device 101 as well as controls the overall operation of the user device 101. The reader unit 1111 reads an original document image, and outputs image data corresponding to the original document image to the printer unit 1112. The reader unit 1111 may store image data in an HDD (Hard Disk Drive) 1105 that is a storage device within the user device 101. The reader unit 1111 may transmit image data to a host computer connected to the network 108 via a network I/F 1114.

The printer unit 1112 prints image data corresponding to the original document read by the reader unit 1111, or image data stored in the HDD 1105 within the user device 101. Also, the printer unit 1112 receives a print job from a host computer connected to the network 108 via the network I/F 1114, and executes print processing. The operation unit 1113 includes a button, a display device, or a liquid crystal display screen with touch-panel input. The operation unit 1113 reports input information corresponding to a user operation input to the general control unit 1110. Also, the operation unit 1113 displays information output by the general control unit 1110.

The general control unit 1110 includes a CPU 1101, ROM 1102, RAM 1103, a HDC (Hard Disk Controller) 1104, and an HDD 1105. The general control unit 1110 further includes a reader I/F 1107, a printer I/F 1108, an operation unit I/F 1109, and a network I/F. The CPU 1101 executes a control program stored on the ROM 1102 or the HDD 1105, and integrally controls the devices connected to a system bus 1106. The RAM 1103 functions as the working area or the like for the CPU 1101. The HDC 1104 controls the HDD 1105. The reader I/F 1107 and the printer I/F 1108 are respectively connected to the reader unit 1111 and the printer unit 1112, and control the devices that are connected thereto. The operation unit I/F 1109 is connected to the operation unit 1113, and controls display to the operation unit 1113 and input processing in response to a user's operation by the operation unit 1113. The network If F 1114 is connected to the network 108, and is employed such that the general control unit 1110 communicates with an external device (for example, the application server 102) on the network 108. The network I/F 1114 is, for example, a network interface card (NIC).

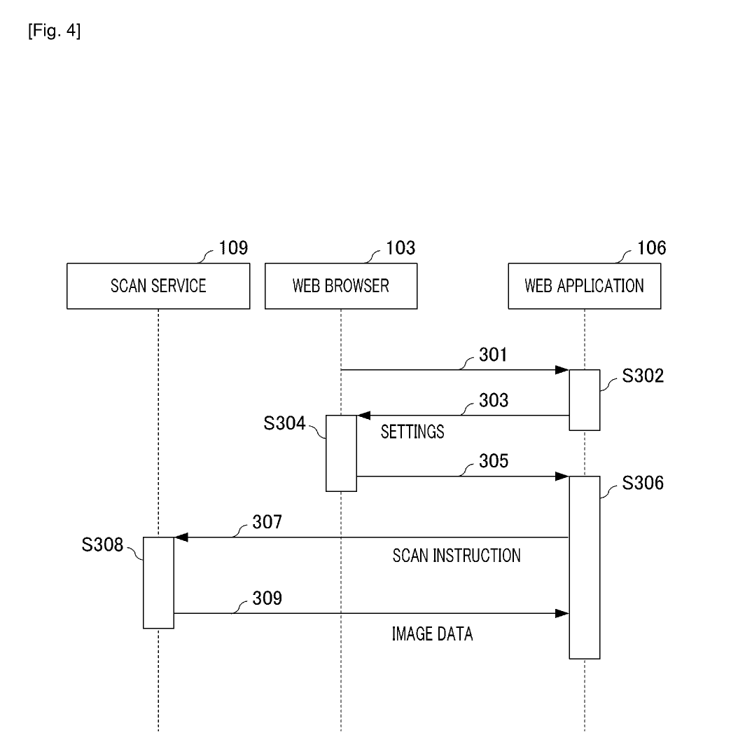

FIG. 4 is a sequence diagram illustrating image data read processing to be executed by the information processing system of the first embodiment. The image data read processing shown in FIG. 4 is executed by user device identifying processing to be described below with reference to FIG. 3 after a user device has been identified. Firstly, the Web browser 103 transmits an HTTP request 301 to the Web application 106, and thus accesses a scan application provided in the Web application 106. The Web application 106 returns an HTTP response 303, which provides an instruction to display a screen for scan settings, depending on the received HTTP request 301 (step S302).

Next, the Web browser 103 displays a screen for scan settings based on the HTTP response 303 that has been received from the Web application 106. Then, the Web browser 103 detects a scan setting complete instruction in response to a user operation input on the screen, and transmits an HTTP request 305 that includes setting contents to the Web application 106 (step S304).

Next, the Web application 106 transmits a scan instruction 307 that directs image scanning to the scan service 109 in accordance with the setting contents included in the HTTP request 305 (step S306). The scan service 109 that has received the scan instruction 307 provides an instruction to an image reading unit provided in the user device 101 about reading an image. Then, the scan service 109 transmits the read image data 309 to the Web application 106 as a response to the scan instruction 307 (step S308).

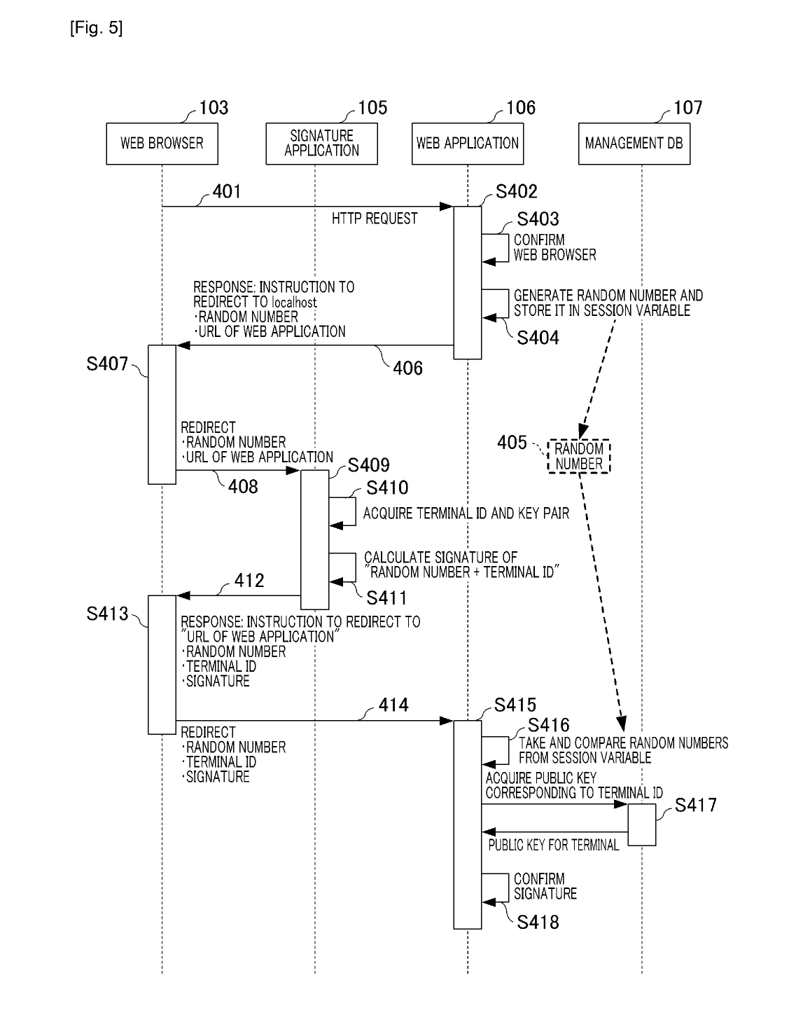

Before the information processing system executes image data read processing as shown in FIG. 4, the Web application 106 needs to recognize reliably the fact that the transmission destination of the scan instruction 307 is the user device 101. Thus, as will be described with reference to FIG. 5, the Web application 106 identifies the user device 101 on which the Web browser 103 operates when the Web browser 103 has accessed the Web application 106.

FIG. 5 is a sequence diagram illustrating identification processing of a user device on which a Web browser operates, which is executed by the information processing system of the first embodiment. Firstly, the Web browser 103 transmits an HTTP request 401 to the Web application 106 that is operated on the server 102.

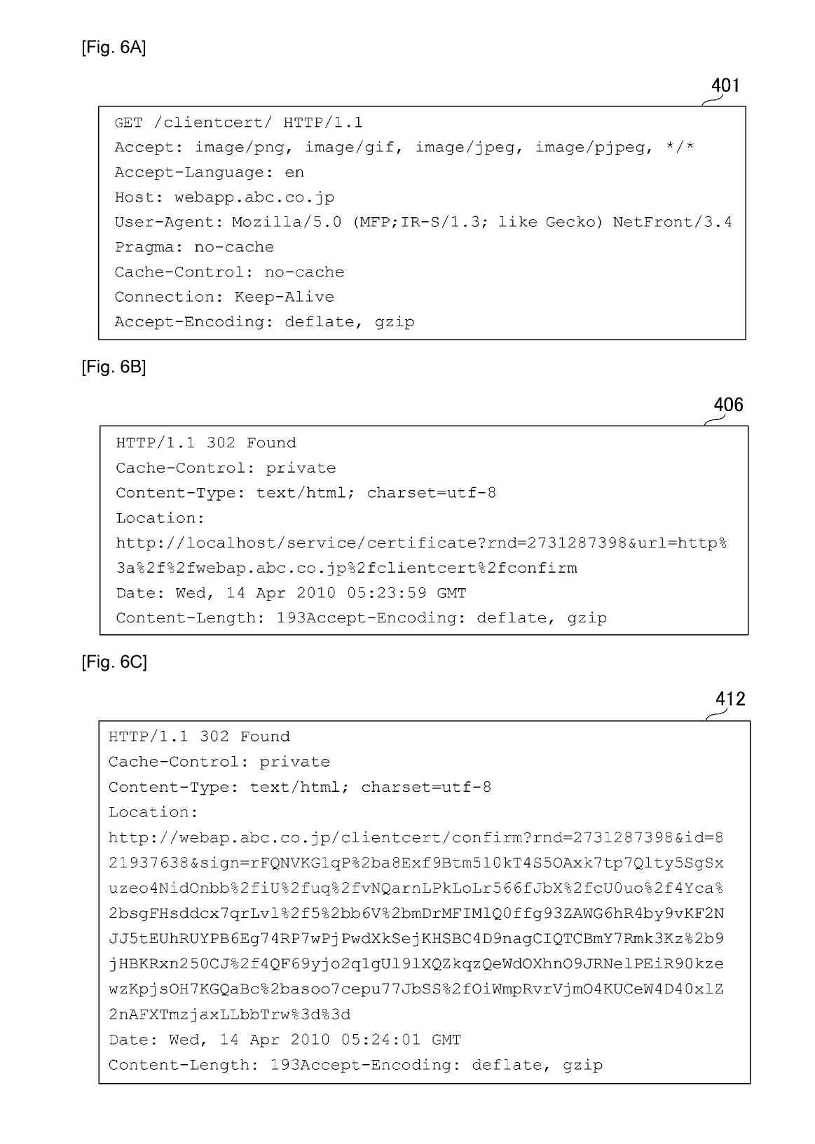

FIG. 6A is a diagram illustrating an example of the HTTP request 401. The character strings “MFP” and “IR-S” in “User-Agent” included in the HTTP request 401 shown in FIG. 6A indicate the fact that the user device 101 is a digital multi-function peripheral.

Referring to FIG. 5, the Web application 106 starts reception processing of the HTTP request 401 (step S402). The Web application 106 acquires the contents of the header “User-Agent” in the HTTP request 401. The character strings “MFP” and “IR-S” are included in the “User-Agent”. Thus, based on the contents of the “User-Agent”, the Web application 106 confirms that the HTTP request 401 has been transmitted from a Web browser in a user device which functions as a digital multi-function peripheral (step S403). In step S403, the Web application 106 cannot confirm that which digital multi-function peripheral (user device) has transmitted the request.

Next, the Web application 106 generates a random number 405, and stores the random number 405 in a session variable of the Web application 106 (step S404). The session variable is a variable that is associated with the session ID of HTTP and is stored in the HTTP application side. A value stored in a variable is shared between the HTTP requests having the same session ID. In other words, the Web application 106 generates a random number that is variable information associated with a communication session between the Web browser 103 and the Web application 106, and stores it in a storage unit.

Next, the Web application 106 returns an HTTP response 406 to the Web browser 103. The HTTP response 406 provides an instruction to the Web browser 103 to redirect the Web browser to the URL of the signature application 105. The HTTP response 406 includes at least the random number 405 and the URL to which an HTTP request 414 to be described below returns (the URL of the Web application 106) as parameters. The Web application 106 passes the random number to the Web browser 103 through a redirect instruction. In other words, the Web application 106 generates and stores unique information (random number) in response to the receipt of a request from a Web browser provided in a user device, and transmits the unique information and an instruction to redirect the Web browser to the signature application 105 to the Web browser.

FIG. 6B is a diagram illustrating an example of the HTTP response 406. Among URL arguments specified by “Location” included in the HTTP response 406, the value specified by “rnd” (rnd argument) is the random number 405. Also, the value specified by “url” (url argument) is a part of the URL of the HTTP request 414. The signature application 105 operates on the same host as the Web browser 103. Thus, the Web browser 103 can access the signature application 105 by specifying “localhost” to a base address. In other words, the Web application 106 specifies “localhost” to the “Location” of the HTTP response 406 regardless of the network address of the user device 101. Accordingly, the Web browser 103 can transfer an HTTP request 408 to the signature application 105 based on the “localhost” specified by the HTTP response 406.

Next, the Web browser 103 performs reception processing of the HTTP response 406 (step S407). The Web browser 103 transmits the HTTP request 408 to the URL of the signature application 105 in the user device 101 specified by the “Location” based on the contents of the HTTP response 406. The HTTP request 408 includes a random number and the URL of the Web application 106 as parameters, which are included in the HTTP response 406. The URL of the Web application 106 is specified as a url argument in the HTTP request 408. Also, the random number is specified as an rnd argument. Thus, the Web browser 103 can pass a random number to the signature application 105 through the redirect to the signature application 105.

Next, the signature application 105 starts reception processing of the HTTP request 408 (step S409). Firstly, the signature application 105 acquires the key pair of the terminal ID and the user device 101 (the pair of a public key and a secret key) from the operation environment of the signature application 105 (step S410). Next, the signature application 105 takes the random number 405 from the HTTP request 408. The signature application 105 calculates (generates) a signature, which is a character string in which the random number 405 is combined with the terminal ID, by using the key pair (step S411). In other words, the signature application 105 generates signature information based on the identification information (the terminal ID) about a user device on which the Web browser 103 operates, the random number, and the secret key corresponding to the user device. Next, the signature application 105 returns an HTTP response 412 to the Web browser 103. The HTTP response 412 provides an instruction to the Web browser 103 to redirect the Web browser to the URL specified by the url argument of the HTTP request 408 (the URL of the Web application 106). The signature application 105 specifies the signature in the HTTP response 412. In other words, the signature application 105 receives unique information (random number) that has been transmitted by the Web browser in accordance with the redirect instruction, and generates signature information based on the received unique information. Then, the signature application 105 transmits an instruction to redirect the Web browser to the Web application, including the signature information and the unique information, to the Web browser.

FIG. 6C is a diagram illustrating an example of the HTTP response 412. The base address of the URL to which the HTTP request 414 is transferred is specified in the “Location” included in the HTTP response 412. More specifically, the signature application 105 specifies the url argument value of the HTTP response 406 (FIG. 6B), i.e., the url argument value of the HTTP request 408, to the URL argument of the “Location” included in the HTTP response 412.

Among the URL arguments specified by the “Location” included in the HTTP response 412, a random number indicated by an rnd argument is a random number indicated by the rnd argument of the HTTP response 406 (FIG. 6B), i.e., a random number indicated by the md argument of the HTTP request 408. The value of an id argument is the value of a terminal ID. The value indicated by the character string of “sign” (the value of sign argument) is the value of the signature that has been calculated in step S411.

Next, the Web browser 103 receives the HTTP response 412 from the signature application 105 (step S413). Based on the contents of the HTTP response 412, the Web browser 103 transmits (redirects) the HTTP request 414 to the URL indicated by the URL argument of the “Location” of the HTTP response 412 (the URL of the Web application 106). The HTTP request 414 includes a random number, a terminal ID, and a signature. Among the URL arguments included in the HTTP request 414, the Web browser 103 assigns the random number included in the HTTP response 412 to the md argument. Also, the Web browser 103 assigns the terminal ID included in the HTTP response 412 to the id argument. Further, the Web browser 103 assigns the signature included in the HTTP response 412 to the sign argument. In other words, the Web browser 103 passes the signature, the random number, and the identification information (the terminal ID) about a user device on which a Web application operates to the Web application 106 through the redirect.

Next, the Web application 106 starts reception processing of the HTTP request 414 (step S415). The Web application 106 acquires a random number from the HTTP request 414, and compares the acquired random number with the random number 405 that has been stored in the session variable in step S404.

More specifically, the Web application 106 acquires the random number 405 corresponding to the communication session between the redirect source, i.e., the Web browser from which the HTTP request is transmitted, and the Web application 106. The Web application determines whether or not the random number 405 matches the random number acquired from the HTTP request 414. Note that the Web application 106 takes the random number 405 from the session variable while at the same time deleting the value of the session variable. The Web application 106 deletes the session variable, and thus the acquisition of the session variable by the Web application 106 will fail when the Web application 106 receives the same request as the HTTP request 414. Also, the Web application 106 deletes the session variable, and thus the random number acquired from the HTTP request 414 does not match the random number 405. When the random number acquired from the HTTP request 414 does not match the random number 405, the Web application 106 returns an HTTP response for directing an error display to the Web browser 103, and the process is ended.

When the random number acquired from the HTTP request 414 matches the random number 405, the Web application 106 acquires the terminal ID indicated by the id argument from the HTTP request 414. Also, the Web application 106 acquires a public key corresponding to the acquired terminal ID from the management DB 107 (step S417). When the Web application 106 fails to acquire the public key, the Web application 106 returns an HTTP response for directing an error display to the Web browser 103, and the process is ended.

Next, the Web application 106 confirms the signature of the character string, in which the random number 405 is combined with the terminal ID included in the HTTP request 414, using the public key acquired in step S417 (step S418). In other words, the Web application 106 receives a redirect from a Web browser, and confirms whether or not signature information included in the redirect is correct when unique information included in the received redirect matches unique information stored in the session variable. More specifically, the Web application 106 determines whether or not the signature included in the HTTP request 414 is correct (whether or not the confirmation of the signature has been successful) using the public key. When the Web application 106 determines that the signature included in the HTTP request 414 is incorrect (the confirmation of the signature has failed), the Web application 106 returns an HTTP response for directing an error display to the Web browser 103. On the other hand, when the Web application 106 determines that the signature included in the HTTP request 414 is correct (the confirmation of the signature has been successful), the Web application 106 executes the following processing. Specifically, the Web application 106 identifies the user device on which the Web browser 103 that has transmitted the HTTP request 401 operates as the user device 101 (the user device corresponding to the terminal ID).

According to the information processing system of the first embodiment, a Web application can identify a user device on which a Web browser operates without implementation of any special framework in the Web browser and without employing a TLS client authentication function.

FIG. 7 is a sequence diagram illustrating print data printing processing to be executed by the information processing system of the second embodiment. The print processing shown in FIG. 7 is executed after a user device has been identified by user device identifying processing to be described below with reference to FIG. 8.

Firstly, the Web browser 103 transmits an HTTP request 802 for the URL of a page for printing a document to the Web application 106. The Web application 106 starts reception processing of the HTTP request 802 (step S803). In other words, the Web application 106 takes the user information included in the HTTP request 802, and acquires a list of documents (user documents) that correspond to a user indicated by the user information. Then, the Web application 106 returns an HTTP response 804 to the Web browser 103. The HTTP response 804 includes an instruction that causes a Web browser to display a list of user documents on the screen such that a document to be printed can be selected. For this purpose, the HTTP response 804 includes an HTML to be used for displaying a list of user documents, where HTML is an abbreviation for “HyperText Markup Language”.

Next, the Web browser 103 receives the HTTP response 804, displays a list of user documents on the screen such that a document to be printed can be selected, and waits for a user operation input (step S805). When the Web browser 103 detects a user operation input, the Web browser 103 transmits an HTTP request 806 that includes information indicating the document, selected by the operation input, to be printed to the Web application 106. Next, the Web application 106 receives the HTTP request 806, and reads the document from, for example, the storage device provided in the application server 102 based on information, included in the HTTP request 806 (step S807), indicating the document to be printed. The Web application 106 converts the read document into a format such that the user device 101 serving as a digital multifunction peripheral can print to thereby generate print data 808. Then, the Web application 106 transmits the print data 808 to an LPD server 801 provided in the user device 101. The LPD server 801 controls print data printing processing (step S809).

Since the Web application 106 imposes the limitation such that a print instruction is accepted only from a registered digital multi-function peripheral, or the Web application 106 transmits print data to a digital multi-function peripheral that transmits the HTTP request 802, the information processing system performs the following processing. Specifically, the Web application 106 identifies the user device 101 on which the Web browser 103 operates when the Web browser 103 has accessed the Web application 106 prior to the execution of print data printing processing shown in FIG. 7.

FIG. 8 is a sequence diagram illustrating identification processing of a user device on which a Web browser operates, which is executed by the information processing system of the second embodiment. The basic operation of user device identifying processing of the second embodiment is the same as that of the first embodiment. Hence, in the processing in the second embodiment, the processing with the same step number as that shown in FIG. 5 is the same as the processing indicated by that step number shown in FIG. 5.

The HTTP response 406 to be transmitted by the Web application 106 includes information included in the HTTP response 406 of the first embodiment as well as a time stamp indicating the current time of the application server 102 on which the Web application 106 operates. The time stamp is specified in the URL argument of the redirect destination. In other words, the Web application 106 passes time information about the application server 102 to the Web browser 103 through transmission of the HTTP response 406.

Likewise, in the URL arguments of each of the HTTP request 408, the HTTP response 412, and the HTTP request 414, the time stamp is additionally included. Thus, the Web browser 103 can pass the time stamp to the signature application 105 through the redirect to the signature application 105. Also, the Web browser 103 can pass the signature, random number, terminal ID, and time stamp to the Web application 106 through the redirect.

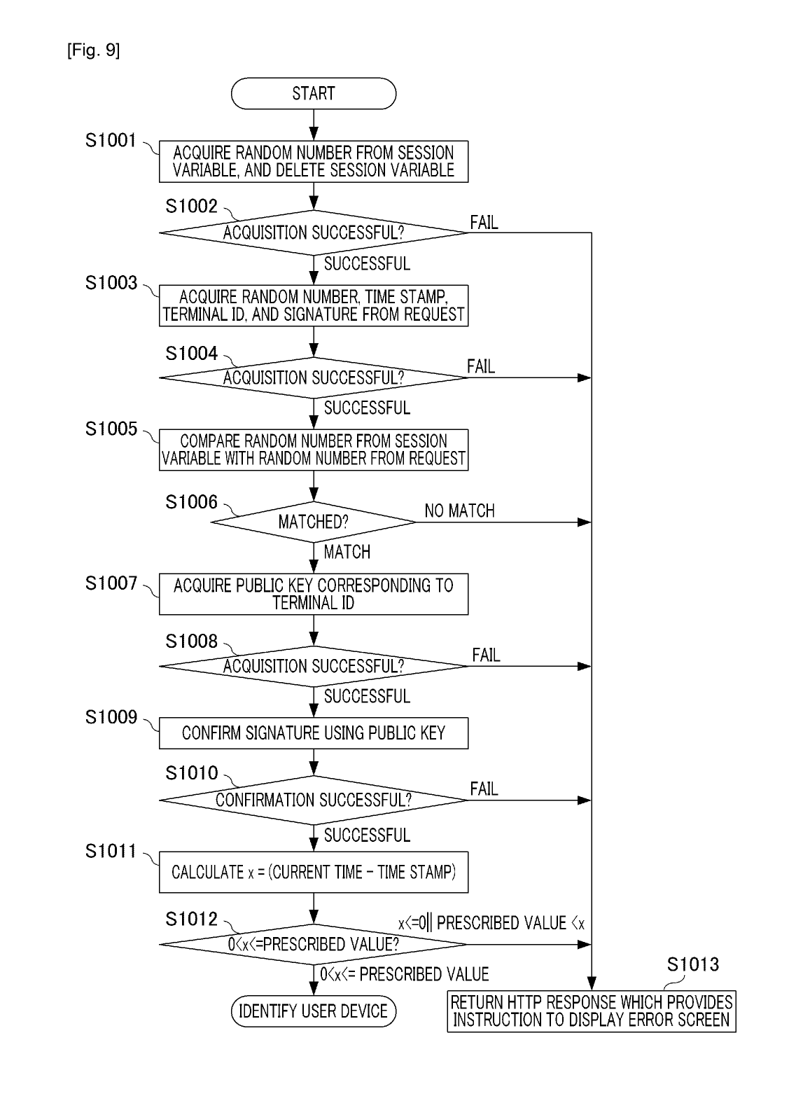

In step S411, the signature application 105 calculates (generates) a signature, which is a character string in which the time stamp, the random number, and the terminal ID are combined, by using the key pair. Then, the signature application 105 returns the HTTP response 412 including the signature to the Web browser 103 (step S411). When the Web browser 103 transmits the HTTP request 414 to the Web application 106, the Web application 106 executes reception processing of the HTTP request 414 to be described below with reference to FIG. 9 (step S901).

FIG. 9 is a diagram illustrating an example of the reception processing flow of an HTTP request 414 by a Web application. Firstly, the Web application 106 acquires the random number 405 from the session variable, and then deletes the session variable (step S1001). The Web application 106 determines whether or not the acquisition of the random number 405 from the session variable has been successful (step S1002). When the acquisition of the random number 405 has failed, the Web application 106 returns an HTTP response, which provides an instruction to display an error screen, to the Web browser 103 (step S1013).

When the acquisition of the random number 405 has been successful, the Web application 106 acquires the random number, time stamp, terminal ID, and signature from the URL argument of the HTTP request 414 (step S1003). The time stamp acquired in step S1003 indicates the current time of the application server 102 when the Web application 106 transmitted the HTTP response 406 shown in FIG. 8 to the Web browser. Referring back to FIG. 9, the Web application 106 determines whether or not the acquisition of the random number, time stamp, terminal ID, and signature has been successful (step S1004). When the acquisition of the random number, time stamp, terminal ID, and signature has failed, the process advances to step S1013. When the acquisition of the random number, time stamp, terminal ID, and signature has been successful, the Web application 106 executes the following processing. In other words, the Web application 106 compares the random number 405 that has been acquired from the session variable in step S1001 with the random number that has been acquired in step S1004 (step S1005), and determines whether or not the both numbers match to each other (step S1006). When the random number 405 acquired from the session variable does not match the random number acquired in step S1004, the process advances to step S1013.

When the random number 405 acquired from the session variable matches the random number acquired in step S1004, the Web application 106 acquires a public key, which corresponds to the terminal ID acquired in step S1003, from the management DB 107 (step S1007). Next, the Web application 106 determines whether or not the acquisition of the public key corresponding to the terminal ID has been successful (step S1005). When the acquisition of the public key corresponding to the terminal ID has failed, the process advances to step S1013.

When the acquisition of the public key corresponding to the terminal ID has been successful, the Web application 106 confirms the signature acquired in step S1004 using the acquired public key (step S1009). The Web application 106 determines whether or not the confirmation of the signature has been successful (step S1010). When the acquisition of signature has failed, the process advances to step S1013. When the acquisition of signature has been successful, the Web application 106 acquires current time information about the application server 102. The Web application 106 calculates the difference (x) between the current time indicated by the acquired current time information and the time indicated by the time stamp acquired in step S1003 (step S1011).

Next, the Web application 106 determines whether or not x is greater than 0 and is equal to or less than a predetermined prescribed value (step S1012). In other words, the Web application 106 determines whether or not x is within a predetermined time range. The fact that x is equal to or less than 0 means that an HTTP request including the same random number as that transmitted in the past has transmitted again. Also, the fact that x is equal to or more than a prescribed value means that a request has not been processed within a certain time period. As an example of the case where x is equal to or more than a prescribed value, a third party takes over an HTTP request on a communication path and then transmits the HTTP request, which has been taken over, to the Web application 106. Thus, when x is equal to or less than 0 or when x is equal to or more than a prescribed value, the process advances to step S1013. When x is greater than 0 and is equal to or less than a predetermined prescribed value, the Web application 106 identifies a user device corresponding to the terminal ID included in an HTTP response 414 as a user device that transmits the HTTP request 401 (step S1014).

The information processing system of the second embodiment identifies a user device on which a Web browser operates based on the difference between the time upon which a Web application provides an instruction to redirect the Web browser to a Web browser and the current time. Thus, as compared with the information processing system of the first embodiment, a user device on which a Web browser operates can be identified more reliably.

According to a user device identifying method performed by the information processing system of the present embodiment described above, a Web application can identify a user device on which a Web browser operates without implementation of any special framework in the Web browser and without employing a TLS client authentication function.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-128428 filed Jun. 4, 2010, which is hereby incorporated by reference herein in its entirety.

1. A user device identifying method comprising:
generating and storing unique information in response to the receipt of a request from a Web browser provided in a user device, and transmitting the unique information and an instruction to redirect to a signature information generation unit provided in the user device to the Web browser by a Web application of a server device;
receiving the unique information transmitted by the Web browser in accordance with the instruction, generating signature information based on the received unique information by the signature information generation unit, and transmitting an instruction to the Web browser to redirect the Web browser to the Web application including the signature information and the unique information by the signature information generation unit; and
receiving a redirect from the Web browser in accordance with the instruction, confirming whether or not signature information included in the redirect is correct when unique information included in the received redirect matches the stored unique information, and identifying the user device when it is confirmed that the signature information is correct by the Web application.

2. A user device identifying method comprising:
receiving, in a reception step, a request from a Web browser in a user device by a Web application provided in an information processing apparatus that executes processing in response to a request received from the Web browser;
providing, in a first redirect instruction step, an instruction to the Web browser which transmits the request to redirect the Web browser to a signature information generation unit that generates signature information corresponding to the user device by the Web application;
redirecting, in a first redirect step, the Web browser to the signature information generation unit by the Web browser;
generating, in a signature information generation step, signature information corresponding to the user device on which the Web browser operates by the signature information generation unit that has received the redirect from the Web browser;
providing, in a second redirect instruction step, an instruction to the Web browser to redirect the Web browser to the Web application and passing the generated signature information to the Web browser through the redirect instruction by the signature information generation unit;
redirecting, in a second redirect step, the Web browser to the Web application and passing the signature information to the Web application by the Web browser;
identifying, in a device identification step, the user device on which the Web browser of the redirect source operates as the user device on which the Web browser which has transmitted the request operates, when the Web application confirms whether or not the signature information is correct and then has confirmed that the signature information is correct.

3. The user device identifying method according to claim 2, wherein:
in the reception step, the Web application generates variable information associated with a communication session between the Web browser and the Web application and stores it in a storage unit, in the first redirect instruction step, the Web application passes the variable information to the Web browser through the redirect instruction,
in the first redirect step, the Web browser passes the variable information to the signature information generation unit through the redirect the Web browser to the signature information generation unit, in the signature information generation step, the signature information generation unit generates the signature information based on identification information about the user device on which the Web browser operates, the variable information, and a secret key corresponding to the user device,
in the second redirect step, the Web browser passes the signature information, the variable information, and the identification information about the user device on which the Web browser operates to the Web application through the redirect, and
in the device identification step, the Web application acquires variable information, which corresponds to a communication session between a Web browser of the redirect source and the Web application, from the storage unit, determines whether or not the acquired variable information matches the variable information passed by the redirect from the Web browser, acquires a public key, which corresponds to the identification information about the user device passed from the Web browser by the redirect, when the variable information corresponding to the communication session matches the variable information passed by the redirect, and determines whether or not the signature information is correct using the acquired public key.

4. The user device identifying method according to claim 3, wherein:
in the first redirect instruction step, the Web application passes time information about the information processing apparatus on which the Web application operates to the Web browser through the instruction to redirect to the signature information generation unit, in the first redirect step, the Web browser passes the time information to the signature information generation unit through the redirect to the signature information generation unit,
in the signature information generation step, the signature information generation unit generates the signature information based on the identification information about the user device on which the Web browser operates, the variable information, the time information, and the secret key corresponding to the user device,
in the second redirect step, the Web browser passes the signature information, the variable information, the identification information about the user device on which the Web application operates, and the time information to the Web application through the redirect, and in the device identification step, the Web application acquires current time information about the information processing apparatus when it is determined that the signature information is correct, determines whether or not the difference between the time indicated by the acquired current time information and the time indicated by the time information passed from the Web browser through the redirect is within a predetermined time range, and identifies the user device on which the Web browser of the redirect source operates as the user device on which the Web browser which has transmitted the request operates when the difference between the time indicated by the acquired current time information and the time indicated by the time information passed from the Web browser is within a predetermined time range.

5. The user device identifying method according to claim 1, wherein the request is an HTTP request.

6. An information processing system comprising:
a user device; and
an information processing apparatus that executes processing in response to a request received from the user device, wherein, the user device comprises:
a Web browser that transmits a request to a Web application, redirects the Web browser to a signature information generation unit in accordance with an instruction given by the Web application that has received the request, redirects the Web browser to the Web application in accordance with an instruction given by the signature information generation unit, and passes the signature information to the Web application; and
a signature information generation unit that receives the redirect from the Web browser, generates signature information corresponding to the user device on which the Web browser operates, provides an instruction to the Web browser to redirect the Web browser to the Web application, and passes the generated signature information to the Web browser through the redirect instruction, and
the information processing apparatus comprises:
the Web application that receives the request from the Web browser provided in the user device, provides an instruction to the Web browser which transmits the request to redirect the Web browser to the signature information generation unit, confirms whether or not the signature information passed through the redirect from the Web browser is correct, and identifies the user device on which the Web browser of the redirect source operates as the user device on which the Web browser which has transmitted the request operates when it is confirmed that the signature information is correct.
